(19) United States
(12) Patent Application Publication
(10) Pub. No.: US 2019/0070893 A1
(43) Pub. Date: Mar. 7, 2019

(54) Laser Engraved Structure with Three-Dimensional Effect Formed on Plane

(71) Applicant: LI DESIGN CORP., Taipei City (TW)

(72) Inventors: Tien-Li Chen, Taipei City (TW); Hung-Po Ou Yang, Chiayi County (TW)

(21) Appl. No.: 15/696,196

(22) Filed: Sep. 6, 2017

(51) Int. Cl. B44C 1/22; B44C 3/00

(52) U.S. Cl. CPC B44C 1/228; B44C 5/043; B44C 3/005

(57) ABSTRACT

A laser engraving structure with three-dimensional effect formed on a plane, includes a substrate and at least one stacking sheets having a color different from a color of the substrate and attached on a processing surface of the substrate in order to form a multi-layered composite wooden material. In addition, the laser engraving technique can be utilized to the stacking surface of the composite wooden board in order to engrave out a desired pattern. Accordingly, a three-dimensional visual effect with great colors at different engraving depths can be achieved along with a gradient effect of different gray scale can be generated among layers of colors such that the texture is of rich colors and vividness.

### (A) TECHNICAL FIELD OF THE INVENTION

The present invention is related to a product structure created by using a laser engraving technique, in particular, to a product utilizing a laser engraving technique to create a three-dimensional visual effect with great number of colors and gradient textures, which is particularly suitable to the application on a wooden engraved structure or similar works.

### (B) DESCRIPTION OF THE PRIOR ART

Laser engraving refers to the use of laser beam to engrave permanent marks of desired patterns or texts etc. on various types of different materials. Since laser engraving performs the processing technique without the use of knives in contact with the materials, there is no wear of knives during such process and no cutting force acting on the workpiece to cause any direct impacts on the workpiece such that there is no occurrence of mechanical deformation. In addition, since the laser engraving technique can utilize the spotting method to achieve the engraving, the presentation of gray scale in the engraved material absorbing different amount of laser energy can be achieved, which is impossible for traditional mechanical engraving. Furthermore, the processing method can cooperate with a digital control system such that it is extremely convenient to perform processing on complicated workpiece. Moreover, the laser engraving technique is of fast production speed, high efficiency and stable quality such that it has become an engraving method of great economic benefits and widely adopted in the industry.

Since the laser engraving can be widely applied to various types of different surfaces, and with the differences in the power and density of the laser generated, various types of different effects can be generated. Currently, the most commonly used material for engraving is wood. In addition, wooden materials undergoing the engraving process can reveal a sense of burning such that an original artistic beauty can be achieved by such burned colors and the wood base color. Furthermore, during the engraving design of patterns and texts, different levels of burning and carbonation can be utilized to create different gray scales in order to increase the layer presentation of the patterns and texts. Nevertheless, such known engraved patterns and texts tend to be similar to black-and-white photos since they show one single color series of layer difference only. In terms of the overall visual effect, known engraved works lack of perspective feelings, and the design of color technique is monotonous and trivial.

### SUMMARY OF THE INVENTION

A primary objective of the present invention is to provide a laser engraved structure with three-dimensional effect, which utilizes the laser engraving technique to present patterns and texts engraved on a plurality of layers of composite wooden boards. In addition, by presenting different colors of laminated layers at different engraving depths, the engraved structure can have a greater diversity of rick colors in order to create a three-dimensional and vivid visual effect.

To achieve the aforementioned objective, the present invention provides a laser engraved structure with three-dimensional effect, comprising a multi-layered composite wooden board, the composite wooden board is formed by a substrate and at least one stacking sheets attached on a processing surface of the substrate and having a color different from a color of the substrate. In addition, the laser engraving technique is utilized to engrave the pattern and text desired to be presented on the stacking sheets. Accordingly, a three-dimensional visual effect achieved by variations of different engraving depths along with rich colors can be created. Furthermore, with the different absorption of laser energy among different colors, the gradient effect of layered feeling can be achieved in order to allow the engraved structure to have diverse and rich colors in order to present a perspective and vivid visual effect.

The technical features of the present invention can be further understood based on the following disclosure of exemplary embodiments along with the accompanied drawings.

### BRIEF DESCRIPTION OF THE DRAWINGS

FIG. 1 is a schematic view showing a structure of a composite wooden board of the present invention;

FIG. 2 is a schematic view showing the process of the creation of the laser engraved structure of the present invention;

FIG. 3 is a schematic view showing the process of a laser engraved pattern of the present invention; and

FIG. 4 is a schematic view showing a completed laser engraved structure of the present invention.

### DETAILED DESCRIPTION OF THE PREFERRED EMBODIMENTS

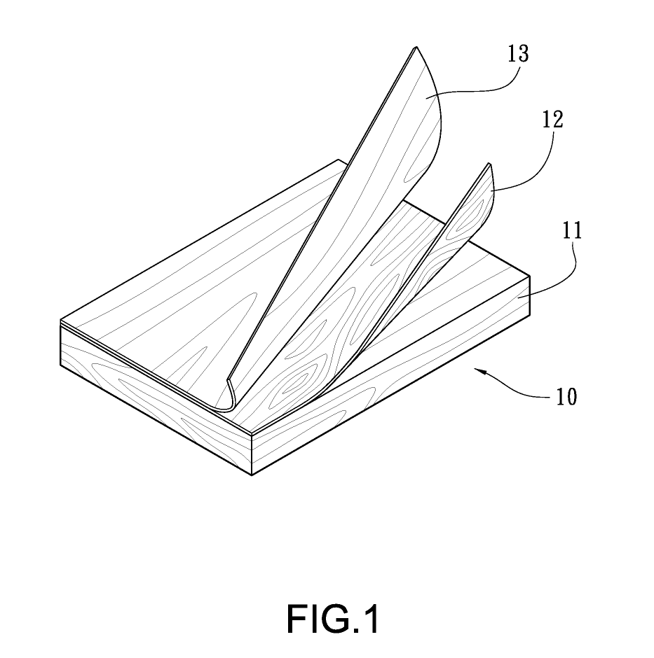

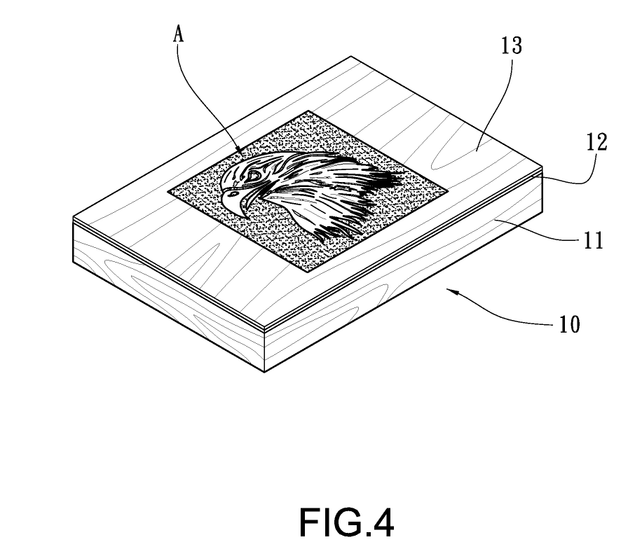

As shown in FIG. 1 and FIG. 4, the present invention provides a laser engraved structure with three-dimensional effect formed on a plane, which mainly utilizes a laser engraving technique to create a desired Pattern A to be formed on a stacking surface of a multi-layered composite wooden board 10; wherein the multi-layered composite wooden board 10 is formed by a substrate 11 and at least one stacking sheets 12, 13 attached onto a processing surface of the substrate 11. In this exemplary embodiment, the stacking sheets comprise a first stacking sheet 12 and a second stacking sheet 12. In addition, each stacking sheet 12, 13 and the substrate 11 are of different colors. During the actual implementation, the stacking sheet 12 of a darker color can be attached to a lower layer portion, and the stacking sheet 13 of a lighter color can be attached to an upper layer portion, as shown in FIG. 1.

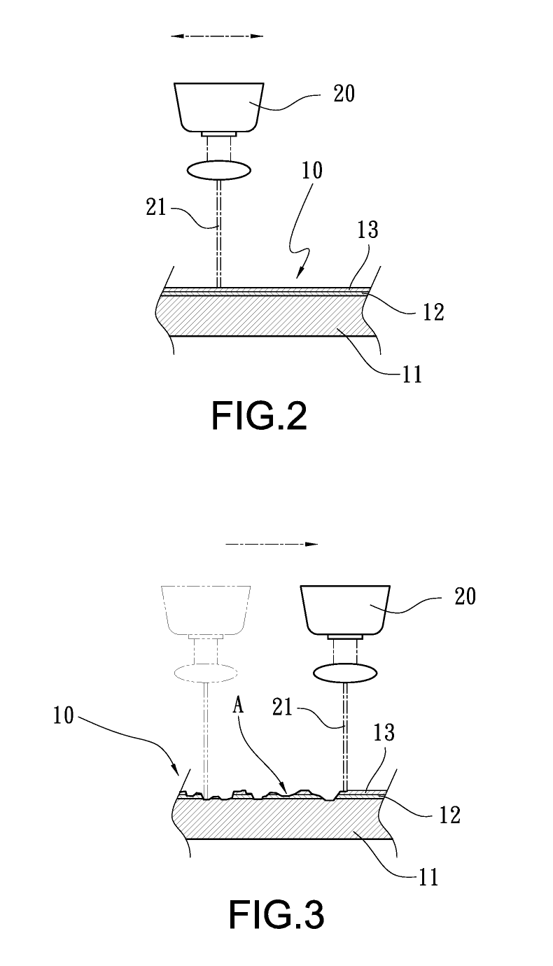

Please refer to FIGS. 2-4. During the creation of the present invention, the multi-layered composite wooden board 10 can be installed on a laser engraving machine 20 such that after programming of application values on a processing machine, the laser engraving machine can be driven to perform high-speed processing, and the laser beam 21 can be projected onto the stacking surface of the multi-layered composite wooden board 10 in order to allow the laser beam to engrave out patterns of different depth variations; therefore, the desired Pattern A with three-dimensional effect can be engraved for presentation. Since the multi-layered composite wooden board 10 of the present invention includes the stacking sheets 12, 13 of different colors on the engraved surface thereof, when the laser engraves to reach stacking sheets 12, 13 of different depths, the color of that layer can be revealed. In addition, when the depth of the laser engraving reaches the substrate 11, the color of the substrate 11 can also be revealed. Moreover, a layered presentation of different gray scale among layers can also be achieved through the different level of carbonation due to the amount of laser energy absorption by each layer. Consequently, the gradient effect of layers of colors can be further achieved such that the overall quality of the laser engraved structure can be enhanced in addition to that the colors presented are diverse and rich in order to create a visual effect of greater perspective and vividness while stimulating consumers' will in purchasing products of such structure.

In view of the above, the laser engraved structure with three dimensional effect formed on a plane of the present invention is of the following practical advantages:

1. The raw material of the multi-layered composite wooden board can be obtained with ease, and the material is not required to be a lumber material. The surface on which the engraving process is to be performed can be formed by wooden sheets of different colors stacked in multiple layers into a composite wooden board for the engraving operation. Therefore, the raw material can be obtained without significant consumption of lumber materials, which is beneficial to environmental protection along with the reduction of generation of cut and trimmed wastes. Consequently, the utilization rate of wooden materials can be optimized in order to reduce the production cost, increase the overall economic benefits and market competitiveness.

2. With the fast and automatic processing of the laser engraving machine, mass production of products can be achieved automatically with multiple working period of times such that labor involved can be minimized while achieving the appealing effect of a three-dimensional engraving on a wooden board surface.

3. With the color changes of different stacking sheets of the multi-layered composite wooden board, one identical engraving theme can be created while achieving a rich content of variations of colors. In addition, the design of the content of the engraving theme, modifications can be made easily via the programming of values of the processing machine; therefore, customized product can have extremely high adaptiveness.

I claim:

1. A laser engraved structure with three-dimensional effect formed on a plane, comprising a multi-layered composite wooden board having a surface engraved by utilizing a laser engraving technique, characterized in that:
the multi-layered composite wooden board is of a laminated formation having a plurality of wooden boards stacked and attached onto each other; said 1 multi-layered composite wooden board comprises a substrate arranged at a bottom portion thereof and at least one layer of stacking sheets having a color different from a color of the substrate and attached onto the substrate; the laser engraving technique is performed on the surface of the multi-layered composite wooden board in order to create engraved layers with color changes on each layer thereof, thereby generating a layered feeling of different gradients of gray scales among the layers thereof to achieve a three-dimensional visual effect.

2. The laser engraved structure with three-dimensional effect formed on a plane according to claim 1, wherein the stacking sheets attached on the substrate comprises a layer quantity selected from any one of two layers, three layers, four layers or five layers.

3. The laser engraved structure with three-dimensional effect formed on a plane according to claim 2, wherein the stacking layers attached onto the substrate are stacked with the stacking layers having darker colors disposed at a lower portion of the multi-layered composite wooden board and the stacking layers having lighter colors disposed at an upper portion of the multi-layered composite wooden board in sequence.
